(19) United States
(12) Patent Application Publication
(10) Pub. No.: US 2023/0258020 A1
(43) Pub. Date: Aug. 17, 2023

(54) HLOCK Temporary Construction Door Latch

(71) Applicant: HERNAN AGUILAR, CARROLLTON, TX (US)

(72) Inventor: HERNAN AGUILAR, CARROLLTON, TX (US)

(21) Appl. No.: 17/670,414

(22) Filed: Feb. 11, 2022

(51) Int. Cl. E05B 9/08; E05B 63/00

(52) U.S. Cl. CPC E05B 9/084; E05B 63/006

(57) ABSTRACT

A Temporary Construction door latch/lock is disclosed which is both rugged and economical. The latch includes a half circle flanged housing which acts as a bushing for a journal portion of an operator. The operator includes 2 slots (For 2″¾ and 2″⅜ size doors) to accommodate the latching and the locking pin that serves also as the handle portion to move the latch back to open the door. At the inner end of the operator, a generally cylindrical latch is placed to the interior of the housing through the face of the door to interact with the frame. The latch moves back and force with respect to the housing and is limited in movement by a spring goes inside the housing. The latch is secured to the operator by a latching and a locking pin, which means to prevent the whole latch to come apart. The housing is fixed to the door by securement means which draws the flange of the housing against the exterior of the door.

### CROSS-REFERENCE TO RELATED APPLICATION

Keeps newly installed doors shut and secure during construction.

### STATEMENT REGARDING FEDERALLY SPONSORED RESEARCH OR DEVELOPMENT

N/A

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

N/A

### BACKGROUND OF THE INVENTION

### (1) Field of the Invention

Temporary Door Hardware

### (2) Description of Related Art Including Information Disclosed Under 37 CFR 1.97 and 1.98

### BRIEF SUMMARY OF THE INVENTION

A Temporary Construction Door Latch/Lock is disclosed which is both rugged and economical.

### BRIEF DESCRIPTION OF THE SEVERAL VIEWS OF THE DRAWING(S)

FIG. 1A shows HOUSING, semi-circle flanges to pressure against bored door hole to keep it in place, outer hexagonal shape, and cylindrical inside to receive the latch. It has 2 slots in each side where the latching and locking pin meet to secure the apparatus all together.

FIG. 1B show: LATCH, it is comprised of a cylindrical plastic apparatus that protrudes inside the door jamb to keep the doors shut and secure.

FIG. 1C shows a frontal back view of the Housing apparatus.

FIG. 1D shows: HOLDING PIN, it is comprised of one plastic piece with round holding handles and an opening to receive the holding pin.

FIG. 1E shows: LOCKING PIN: it is comprised of one plastic piece with a cylindrical handle and a arrow style locking mechanism that once introduced into the latching pin secures HLOCL all together into the door.

FIG. 2a, FIG. 2b, FIG. 2c, FIG. 2d and FIG. 2e shows different views of the structure shown on FIG. 1A and FIG. 1C.

FIG. 3a and FIG. 3b shows a different view of the structure shown on FIG. 1B.

FIG. 4a and FIG. 4b shows a different view of the structure shown on FIG. 1D.

FIG. 5a shows a different view of the structure shown on FIG. 1E.

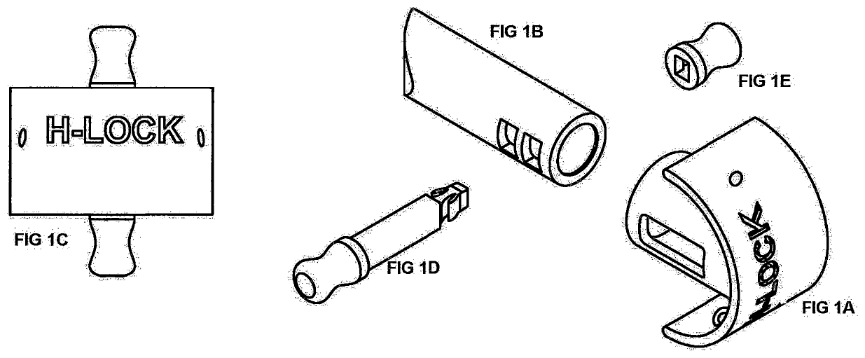

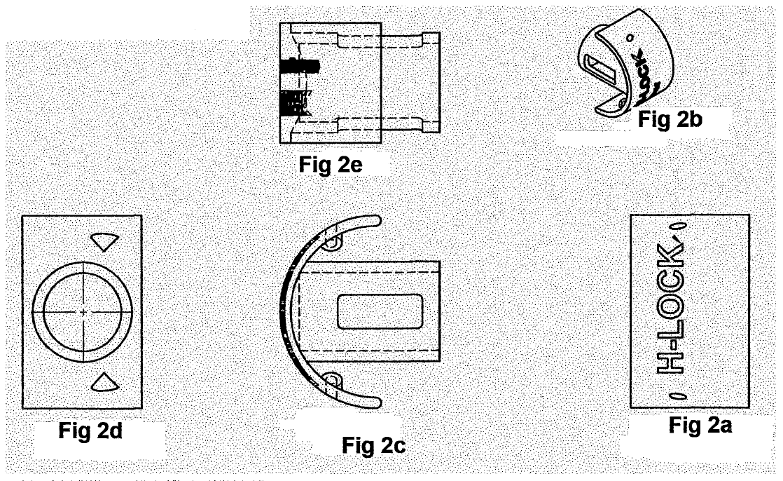

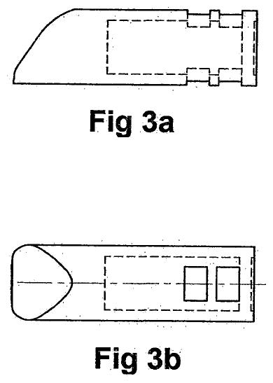

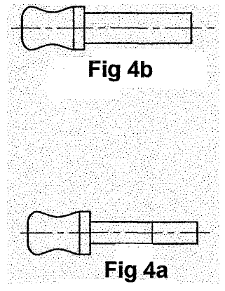

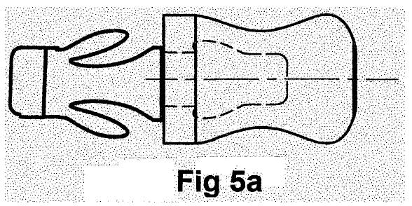

### DETAILED DESCRIPTION OF THE INVENTION

A Temporary Construction door latch/lock is disclosed which is both rugged and economical. The latch includes a half circle flanged housing which acts as a bushing for a journal portion of an operator. The operator includes 2 slots (For 2″¾ and 2″⅜ size doors) to accommodate the latching and the locking pin that serves also as the handle portion to move the latch back to open the door. At the inner end of the operator, a generally cylindrical latch is placed to the interior of the housing through the face of the door to interact with the frame. The latch moves back and force with respect to the housing and is limited in movement by a spring goes inside the housing. The latch is secured to the operator by a latching and locking pin, which means to prevent the whole latch to come apart. The housing is fixed to the door by securement means which draws the flange of the housing against the exterior of the door.

### SEQUENCE LISTING (SEE MPEP § 2424 AND 37 CFR 1.821-1.825

A “Sequence Listing” is required on paper if the application discloses a nucleotide or amino acid sequence as defined in 37 CFR 1.821(a) and if the required “Sequence Listing” is not submitted as an electronic document either on compact disc or as a text file via the Office electronic filing system (EFS-Web.)

1- A Temporary Construction Door Latch/Lock for securing a pivoting door, which door defines a door orifice, to a door frame in a door closed position comprising:
a). A Housing which has a flange with a general shape of a semi-circle, which acts as a bushing for a journal portion of an operator;
b). Includes a cylindrical hollow longitudinal apparatus that acts as a latch to hold the door in place, said apparatus has 2 slots to select different door sizes, 2:⅜ and 2″¾;
c). Slots that receive a rectangular long piece that acts as a holding pin;
d). Holding ping receives the locking pin that has an arrow design that once inserted keep the latch in place.
